(19) United States
(12) Patent Application Publication
(10) Pub. No.: US 2024/0380591 A1
(43) Pub. Date: Nov. 14, 2024

(54) SYNC DATA ACROSS APPARATUSES

(71) Applicant: Meta Platforms Technologies, LLC, Menlo Park, CA (US)

(72) Inventors: Sanjiban KUNDU, Medford, MA (US); Gowrish GIRIDHARAN, Orpington (GB); Erik WOLSHEIMER, Palo Alto, CA (US); Rushabh SHAH, Jersey City, NJ (US); Junhong PAN, Cambridge, MA (US); Leonard David RICCI, III, Cambridge, MA (US); Gong ZHANG, Burlington, MA (US); Litao SHEN, Westford, MA (US)

(73) Assignee: Meta Platforms Technologies, LLC, Menlo Park, CA (US)

(21) Appl. No.: 18/654,856

(22) Filed: May 3, 2024

Related U.S. Application Data
(60) Provisional application No. 63/501,051, filed on May 9, 2023.

(51) Int. Cl. H04L 9/32

(52) U.S. Cl. CPC H04L 9/32

(57) ABSTRACT

According to examples, an apparatus may include an input device, a processor, and a memory on which is stored machine-readable instructions that, when executed by the processor, cause the processor to determine that an input data has been received from or collected by the input device. The instructions may also cause the processor to determine that the input data is to be synced with data on a remote apparatus. In addition, based on a determination that the input data is to be synced, the processor may encrypt the input data and may output the encrypted input data.

### CLAIM FOR PRIORITY

This patent application claims the benefit of priority to U.S. Provisional Patent Application No. 63/501,051, filed on May 9, 2023, entitled “Sync Data Across Apparatuses,” the disclosure of which is hereby incorporated by reference in its entirety.

### TECHNICAL FIELD

This patent application relates generally to electronic apparatuses. Particularly, this patent application relates to syncing data across the electronic apparatuses.

### BACKGROUND

With recent advances in technology, prevalence and proliferation of content creation and delivery have increased greatly in recent years. In particular, interactive content such as virtual reality (VR) content, augmented reality (AR) content, mixed reality (MR) content, and content within and associated with a real and/or virtual environment (e.g., a “metaverse”) has become appealing to consumers. Wearable devices, such as a wearable eyewear, wearable headsets, head-mountable devices, and smartglasses, have gained in popularity as forms of wearable systems. Users may have devices in addition to such wearable devices, including smartphones, smartwatches, and laptops, to name a few types of devices. As a result, users may have a relatively wide variety of devices to track, configure, and use.

### BRIEF DESCRIPTION OF DRAWINGS

Features of the present disclosure are illustrated by way of example and not limited in the following figures, in which like numerals indicate like elements. One skilled in the art will readily recognize from the following that alternative examples of the structures and methods illustrated in the figures can be employed without departing from the principles described herein.

FIG. 1 illustrates a block diagram of an environment in which an apparatus may send and/or receive data to be synced across multiple apparatuses, in accordance with an example of the present disclosure.

FIGS. 2 and 3, respectively, illustrate block diagrams of the apparatus depicted in FIG. 1, in accordance with examples of the present disclosure.

FIG. 4 illustrates a block diagram of a system that includes features of the apparatus depicted in FIGS. 1-3, in accordance with an example of the present disclosure.

FIG. 5 illustrates a flow diagram of a method of syncing input data with data stored on a remote apparatus, according to an example of the present disclosure.

### DETAILED DESCRIPTION

For simplicity and illustrative purposes, the present application is described by referring mainly to examples thereof. In the following description, numerous specific details are set forth in order to provide a thorough understanding of the present application. It will be readily apparent, however, that the present application may be practiced without limitation to these specific details. In other instances, some methods and structures readily understood by one of ordinary skill in the art have not been described in detail so as not to unnecessarily obscure the present application. As used herein, the terms “a” and “an” are intended to denote at least one of a particular element, the term “includes” means includes but not limited to, the term “including” means including but not limited to, and the term “based on” means based at least in part on.

Disclosed herein are apparatuses and methods for syncing data across multiple electronic apparatuses in a secure and efficient manner. The electronic apparatuses are referenced herein as “apparatuses.” As discussed herein, a processor of an apparatus may determine that an input data has been received from or collected by an input device of the apparatus and may determine that the input data is to be synced with data stored on a remote apparatus. The processor may determine whether the input data is to be synced based on, for instance, the type of the input data, whether the input data has changed since a synchronization event, and/or the like. In some examples, the input data may be synced across the apparatuses to provide consistent user experience across the apparatuses as well as to ensure that consistent data is stored across the apparatuses.

The processor may also encrypt the input data based on a determination that the input data is to be synced with data stored on the remote apparatus and may output the encrypted input data. The processor may output the encrypted input data directly to the remote apparatus via a local connection, such as a Bluetooth™ connection, a Wifi connection, or the like. In addition, or alternatively, the processor may output the encrypted input data to a server from which the remote apparatus may retrieve the encrypted input data.

According to examples disclosed herein, the processor may determine whether the input data is to be synced and may output the input data based on a determination that the input data is to be synced. As a result, the processor may not output all of the input data that the processor receives, but instead, may output certain types of input data, e.g., input data that the processor has determined is to be synced. A technical improvement afforded through implementation of the features of the present disclosure may thus be that the amount of data that the processor outputs may significantly be reduced, which may improve the battery life of the apparatus.

According to examples disclosed herein, the processor may encrypt the input data prior to outputting the inputted data to a remote apparatus or a server. In some examples, the processor may encrypt the input data in a manner that may prevent the server from being able to decrypt the input data and thus, the input data may be passed through the server to the remote apparatus without the server identifying the contents of the input data. For instance, the processor may encrypt the input data using a key that is known to the remote apparatus but that is unknown to the server. Through implementation of features disclosed herein, the input data may securely be communicated to the remote apparatus, which may enhance security associated with the communication of the input data.

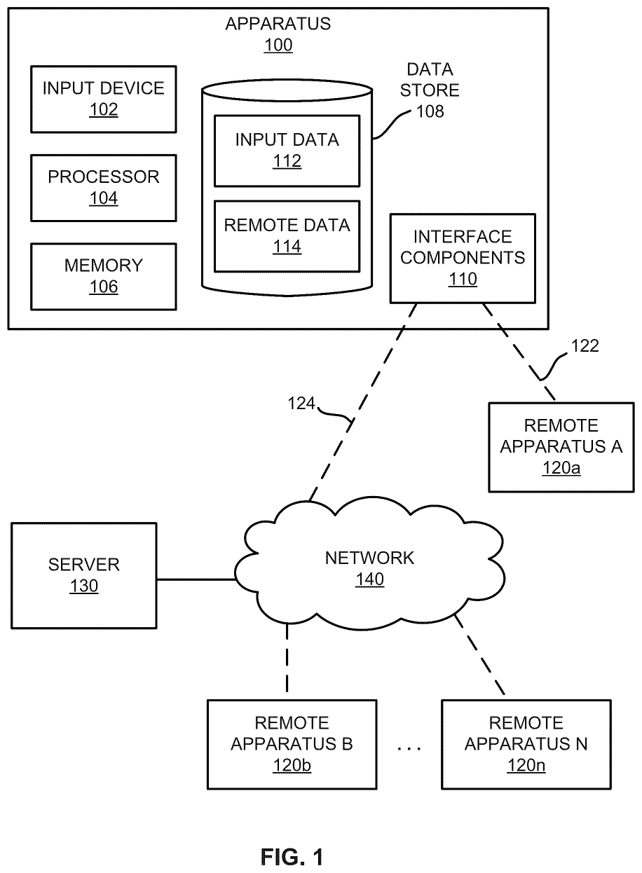

FIG. 1 illustrates a block diagram of an environment in which an apparatus 100 may send and/or receive data to be synced across multiple apparatuses 120a-120n, in accordance with an example of the present disclosure. The apparatus 100 may be a smart device, such as smartglasses, a virtual reality (VR) headset, an augmented reality (AR) headset, a smartwatch, a smartphone, a tablet computer, a smart wristband, and/or the like. In any of these examples, the apparatus 100 may include an input device 102, a processor 104, a memory 106, and a data store 108.

As also shown in FIG. 1, the apparatus 100 may communicate with one or more of the remote apparatuses 120a-120n via interface components 110. The variable “n” may represent a value that is greater than one. The interface components 110 may include hardware and/or software that may enable communication of data between the apparatus 100 and the remote apparatuses 120a-120n. The communication of the data may be from the apparatus 100 to the remote apparatuses 120a-120n, from the remote apparatuses 120a-120n to the apparatus 100, or both.

According to examples, the interface components 110 may enable direct wireless communication with a remote apparatus 120a as denoted by the dashed line 122. In these examples, the wireless communication may be made through a Bluetooth™ connection with the remote apparatus 120a, a WiFi connection with the remote apparatus 120a, or the like.

In addition or in other examples, the interface components 110 may enable the apparatus 100 to communicate to a server 130 via a network 140, which may be the Internet and/or a combination of the Internet and other networks. The communication between the apparatus 100 and the network 140 is denoted by the dashed line 124. In these examples, the interface components 110 may enable the apparatus 100 to communicate to an access point, a gateway, etc., through a Bluetooth™ connection, a Wifi connection, an Ethernet connection, or the like. The interface components 110 may additionally or alternatively include hardware and/or software to enable the apparatus 100 to communicate to the network 140 via a cellular connection.

The remote apparatuses 120a-120n may each be a smart device, such as smartglasses, a VR headset, an AR headset, a smartwatch, a smartphone, a tablet computer, and/or the like. In addition, each of the remote apparatuses 120a-120n may include components similar to those discussed with respect to the apparatus 100. In this regard, the remote apparatuses 120a-120n may communicate with other remote apparatuses 120a-120n and/or the server 130 in manners similar to those discussed above with respect to the apparatus 100.

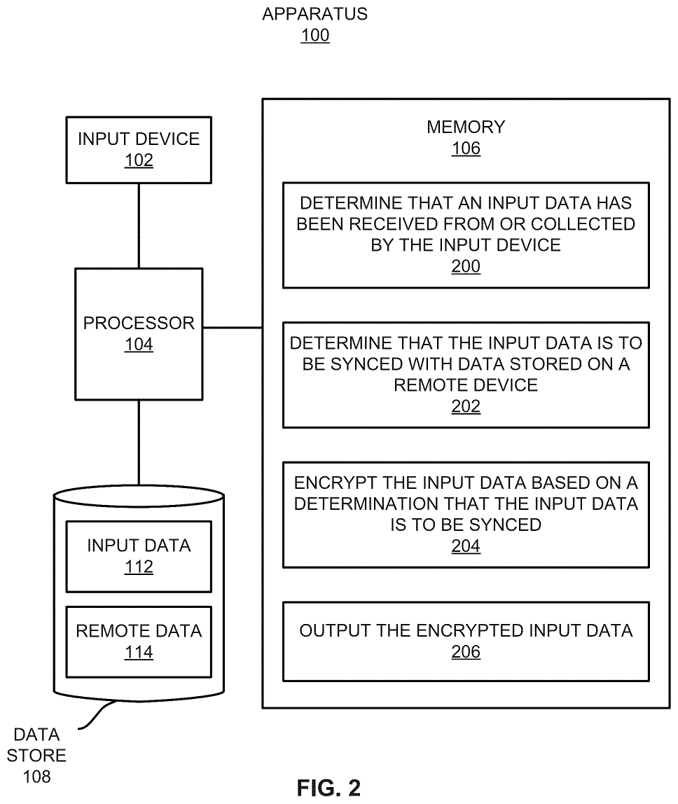

FIG. 2 illustrates a block diagram of the apparatus 100 depicted in FIG. 1, in accordance with an example of the present disclosure. The input device 102 may be any suitable type of device through which a user may input instructions or data and/or interact with the apparatus 100. For instance, the input device 102 may include a touchscreen display, a microphone, a touchpad, a mouse, a camera, etc. As some examples, a user may input instructions to the apparatus 100 through a voice command via the microphone, a gesture command via the camera, and/or a touch command via the touchscreen display.

The input device 102 may additionally or alternatively include any suitable device that may track a feature of the apparatus 100 and/or a user of the apparatus 100. For instance, the input device 102 may include a sensor, a global positioning system device, a step counter, etc. By way of particular example, the input device 102 may track a health-related condition of the user, such as the user's heartrate, blood pressure, movements, steps, etc.

The processor 104 may perform various processing operations and may control operations of various components of the apparatus 100. The processor 104 may be a semiconductor-based microprocessor, a central processing unit (CPU), an application-specific integrated circuit (ASIC), a field-programmable gate array (FPGA), and/or other hardware device. The processor 104 may be programmed with software and/or firmware that the processor 104 may execute to control operations of the components of the apparatus 100.

The memory 106, which may also be termed a computer-readable medium 106, may be an electronic, magnetic, optical, or other physical storage device that contains or stores executable instructions 200-206. The memory 106 may be, for example, Random Access memory (RAM), an Electrically Erasable Programmable Read-Only Memory (EEPROM), a storage device, or an optical disc. For instance, the memory 106 may have stored thereon instructions that the processor 104 may fetch and execute. The data store 108 may also be a computer-readable medium similar to the memory 106. In some examples, the data store 108 and the memory 106 may be the same component.

The processor 104 may execute the instructions 200 to determine that an input data 112 has been received from or collected by the input device 102. The input data 112 may be an instruction that a user has inputted to the apparatus 100 through the input device 102. For instance, the input data 112 may include an instruction by a user to change a setting on the apparatus 100, such as a language used by the apparatus 100 to communicate with the user, a gender of a user assistant voice on the apparatus 100, a background color scheme of images displayed on the apparatus 100, a volume setting of the apparatus 100, and/or the like. The input data 112 may also or alternatively include inputs to another device, such as taking an action from one device to another device, synchronizing alerts between devices, identifying locations of devices on other devices, etc.

By way of particular example, the apparatus 100 may be a smartphone and the remote apparatus 120a may be a pair of smartglasses. In this example, a user of the apparatus 100 may set a theme or interface setting of the apparatus 100 to a certain type of theme or interface setting. For instance, the user may set the apparatus 100 to use a female voice when communicating with the user via audio. In addition, by syncing such input data 112 on the remote apparatus 120a, the remote apparatus 120a may provide a backup location for storage of the input data 112.

In addition, or as other examples, the input data 112 may be data pertaining to a tracked feature of the apparatus 100 and/or a user of the apparatus 100. The tracked feature may include a geographic location of the apparatus 100 as determined by a GPS device, a number of steps that a user of the apparatus 100 has taken over a certain time period, the user's heartrate, the user's blood pressure, the estimated amount of calories that the user has burned over a certain time period, etc. As an example, the remote apparatus 120a may be used to identify the location of the apparatus 100 using the input data 112. As another example, the input data 112 may be data pertaining to well-being content, such as meditation music/videos, meditation podcasts, success stories, etc., that the user may listen to or watch on their devices. As a further example, the input data 112 may be data pertaining to a user's audio journey, e.g., a user may say something as a way to reflect on their day on the apparatus 100.

The processor 104 may execute the instructions 202 to determine that the input data 112 is to be synced with data stored on a remote apparatus 120a. The processor 104 may determine whether the input data 112 includes a type of data that is to be synced with the data stored on the remote apparatus 120a. For instance, a list of the types of data that are to be synced with the data stored on a remote apparatus 120a or on multiple remote apparatuses 120a-120n may be stored in the data store 108. The types of data that are to be synced with the data on the remote apparatus(es) 120a-120n may include any of the types of data discussed above and may be stored in a look-up table or other suitable format. The types of data that are not to be synced may include types of data that may be specific to the apparatus 100 and that may thus not be applicable to the remote apparatus(es). In some examples, instead of the types of data that are to be synced being stored in the data store 108, the types of data that are not to be synced may be stored in the data store 108.

In addition, the processor 104 may determine the type of the input data 112 and may compare that type against the list of the types of data. Based on the comparison, the processor 104 may determine that the input data 112 is or is not to be synced with the data on the remote apparatus 120a. That is, based on a determination that the input data 112 includes a type of data that is to be synced with the data on the remote apparatus 120a, the processor 104 may determine that the input data 112 is to be synced with the data on the remote apparatus 120a. However, based on a determination that the input data 112 does not include a type of data that is to be synced with the data on the remote apparatus 120a, the processor 104 may determine that the input data 112 is not to be synced with the data on the remote apparatus 120a.

In addition, or alternatively, to determine whether the input data 112 is to be synced with the data on the remote apparatus 120a, the processor 104 may determine whether the input data 112 includes data that has been changed from a prior synchronization event. In other words, the processor 104 may determine whether the input data 112 matches a previously stored input data 112 or differs from a previously stored input data 112. By way of example in which the input data 112 is a voice assistant setting, the processor 104 may determine whether the input data 112 is a change to the voice assistant setting.

The processor 104 may determine that the input data 112 is to be synced with the remote apparatus 120a based on a determination that the input data 112 includes data that has been changed from the prior synchronization event. In some examples, the processor 104 may determine that the input data 112 is to be synced based on both a determination that the input data 112 has been changed and is a type of data that is to be synced. However, based on a determination that the input data 112 is not data that has been changed and/or does not match a type of data that is to be synced, the processor 104 may determine that the input data 112 is not to be synced with the remote apparatus 120a. The processor 104 may determine that the input data is data that has been changed, for instance, in instances in which the input data 112 is not currently stored on the remote apparatus 120a, e.g., the input data 112 constitutes new data for the remote apparatus 120.

The processor 104 may execute the instructions 204 to encrypt the input data 112 based on a determination that the input data 112 is to be synced with the data on the remote apparatus 120a. The processor 104 may employ any suitable encryption technique to encrypt the input data 112. For instance, the processor 104 may employ an end-to-end encryption (E2EE) method, such as, RSA, AES, Elliptic Curve Cryptography (ECC), or the like. In addition, in employing E2EE, the processor 104 may combine both symmetric and asymmetric encryption by using a secure key exchange protocol such as Diffie-Hellman to generate and share a symmetric key. This symmetric key may be used to encrypt and decrypt the actual input data 112. In one regard, by using E2EE to encrypt the input data 112, the input data 112 may be communicated to the server 130 without the server 130 being able to decrypt and view the input data 112. As a result, the input data 112 may be kept private from the server 130.

The processor 104 may execute the instructions 206 to output the encrypted input data 112. According to examples, the processor 104 may automatically output the encrypted input data 112 to the network 140 via the connection 124 when the connection 124 between the apparatus 100 and the network 140 is established. In addition, the processor 104 may address the encrypted input data 112, which may be IP packets, to be delivered to the server 130. In these examples, the remote apparatus(es) 120a may obtain the encrypted input data 112 from the server 130 via the network 140. As discussed herein, the input data 112 may be encrypted using E2EE in which the remote apparatus(es) 120a may be the opposite end of the encryption pair and thus, the server 130 may not be able to decrypt and view the input data 112.

In other examples, the processor 104 may determine whether the apparatus 100 has connected to the remote apparatus 120a via a local connection, e.g., a Bluetooth™, a Wifi connection, or the like, and may communicate the encrypted input data 112 to the remote apparatus 120a based on a determination that the apparatus 100 is in communication with the remote apparatus 120a. In these examples, the processor 104 may wait to output the encrypted input data 112 to the remote apparatus 120a until the connection has been established. In other words, the processor 104 may not output the encrypted input data 112 until and unless the connection has been established, which may conserve a battery life of the apparatus 100.

In any of the examples discussed herein, the remote apparatus(es) 120a-120n that obtains the encrypted input data 112 may update the data stored on the remote apparatus(es) 120a-120n with the input data 112. Thus, for instance, the remote apparatus(es) 120a-120n may have common settings and/or themes as the apparatus 100. By way of particular example, the remote apparatus(es) 120a-120n may have the same voice assistant settings as the apparatus 100. As a result, the user experiences may be consistent across the apparatus 100 and the remote apparatuses 120a-120n without requiring that the user manually change the settings across all of the apparatuses 100, 120a-120n. Additionally, other types of data, such as a user's health condition may automatically be shared across the apparatuses 100, 120a-120n.

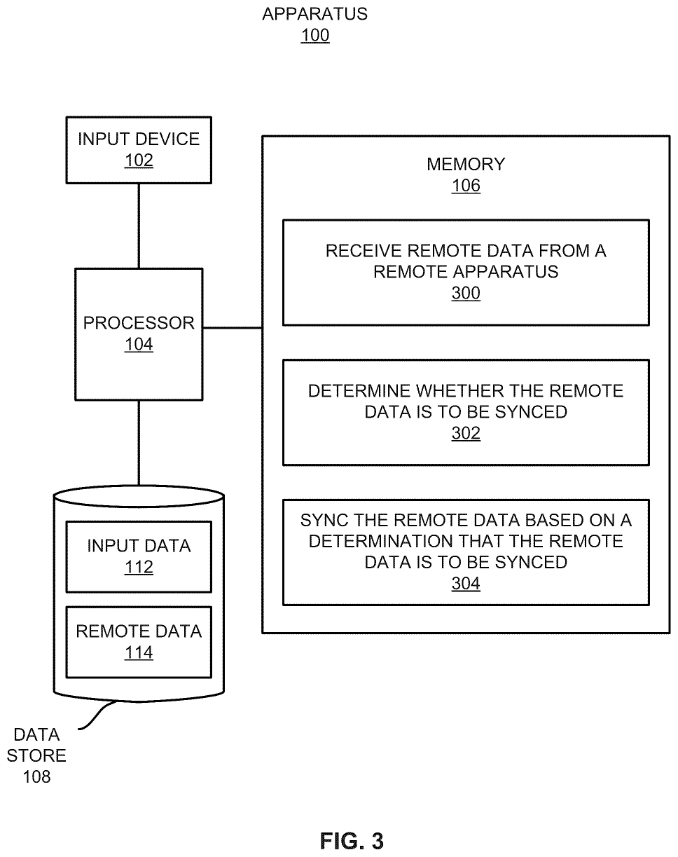

FIG. 3 illustrates a block diagram of the apparatus 100 depicted in FIG. 1, in accordance with an example of the present disclosure. As shown in FIG. 3, the memory 106 may have stored thereon instructions 300-304 that the processor 104 may execute when remote data 114 is received from a remote apparatus 120a.

The processor 104 may execute the instructions 300 to receive remote data 114 from a remote apparatus 120a. The remote data 114 may be similar to the input data 112, but may have been collected or received by the remote apparatus 120a and communicated to the apparatus 100. According to examples, the apparatus 100 may directly receive the remote data 114 from a remote apparatus 120a via the local connection 122. In other examples, the apparatus 100 may receive the remote data 114 from the server 130 via the connection 124 with the network 140. In either of these examples, the remote apparatus 120a may have received or collected the remote data 114 on the remote apparatus 120a, for instance, an input device (not shown) of the remote apparatus 120a.

In some examples, the remote apparatus 120a may have encrypted the remote data 114 prior to communicating the remote data 114 to the apparatus 100. For instance, the remote apparatus 120a may have encrypted the remote data 114 using an E2EE scheme. In these examples, the processor 104 may have the decryption key and may thus decrypt the encrypted remote data 114 using the decryption key. The processor 104 may also analyze the decrypted remote data 114.

Particularly, the processor 104 may execute the instructions 302 to determine whether the remote data 114 includes a type of data that is to be synced with data stored on the apparatus 100, e.g., the data store 108. For instance, the processor 104 may determine a type of the remote data 114 and may compare that type with the types of data that are to be synced with data stored on the data store 108. The processor 104 may determine that the remote data 114 is to be synced based on a determination that the remote data 114 type matches a type of data that is to be synced.

In addition, or alternatively, the processor 104 may determine whether the remote data 114 includes data that has been changed from a prior synchronization event. In other words, the processor 104 may determine whether the remote data 114 is an updated version of the data in a prior synchronization event. The processor 104 may determine that the remote data 114 is to be synced with the data stored on the apparatus 100 based on a determination that the remote data 114 includes data that has been changed. In some examples, the processor 104 may compare timestamps associated with the remote data 114 and the stored data and may determine that the remote data 114 is to be synced if the timestamp of the remote data 114 is later than the timestamp of the stored data. In addition, the processor 104 may determine that the remote data 114 is not to be synced with the stored data based on a determination that the remote data 114 includes data that has not been changed, e.g., is the same as the stored data.

The processor 104 may execute the instructions 304 to sync the remote data 114 with the data stored on the apparatus 100 based on a determination that the remote data 114 is to be synced. The processor 104 may sync the remote data 114 with the stored data by, for instance, replacing the stored data with the remote data 114 or adding the remote data 114 to the stored data. According to examples, the remote apparatuses 120a-120n may execute similar operations to sync the input data 112 when the remote apparatuses 120a-120n receive the input data 112 from the apparatus 100.

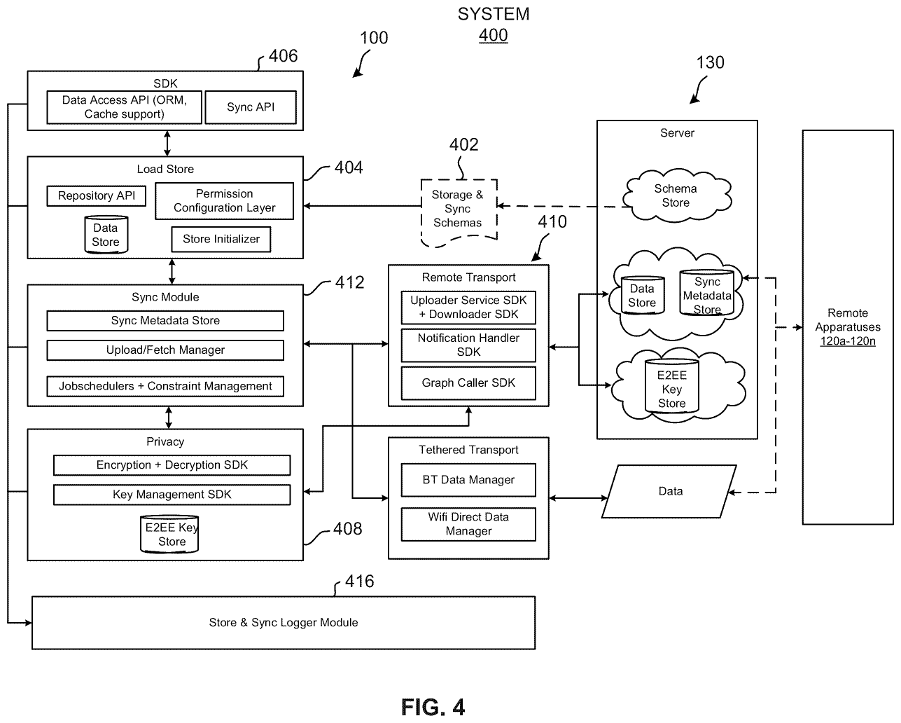

FIG. 4 illustrates a block diagram of a system 400 that includes features of the apparatus 100 depicted in FIGS. 1-3, in accordance with an example of the present disclosure. Generally speaking, the system 400 illustrates features of the apparatus 100, the server 130, and the remote apparatuses 120a-120n that may enable the processor 104 to sync input data with the remote apparatuses 120a-120n.

As shown, the features of the apparatus 100 may integrate with schema management modules to use the storage and sync schemas 402 to create a local storage layer (load store 404) for the input data 112 that is to be synced with a remote apparatus 120a or to sync remote data 114 that is to be synced with data on the apparatus 100. The processor 104 may use a mixture of code-gen+custom code to create the ORM layer (in the SDK 406) for clients to use to securely access their data and ensure forward and backwards compatibility. The processor 104 may also integrate with a privacy module 408, a transport module 410, and a sync module 412 to enable end-to-end encrypted data syncs across the apparatuses 100, 120a-120n. The processor 104 may further integrate with a tethered device (remote apparatus 120a) and an untethered device (server 130) through remote and tethered transports and may ensure eventual input data 112 syncs. The processor 104 may still further integrate with the server 130, which may manage data, sync metadata, and E2EE keys. The processor 104 may still further integrate with a store and sync logger module 416 to ensure that consistent logging is done for all storage and sync use cases.

FIG. 4 also shows the following components:

| Components | Description |
|---|---|
| SDK 406 | Callers may integrate SDK 406 from their apps |
| | and use to interact with the instructions 200-206. |
| | The SDK 406 may allow callers to access their |
| | data (that may include both local and remote |
| | sources) and trigger sync mechanisms. |
| ORM schemas | ORM schemas may define the data models, DB |
| | tables and indices, and queries. |
| Configuration schemas | Configuration schemas may define the storage |
| | and sync configurations such as (sync direction, |
| | how often to sync, how to handle conflicts, privacy |
| | modes, who has access to read/write data) etc. |
| Schema management | The schema management may be a module that |
| | helps clients manage their schemas and their |
| | evolution. |
| Local storage code | The local storage code generation module may |
| generation module | help create usable Kotlin, Swift and C++ code for |
| | clients to use. This module may be fully auto |
| | generated or may have some custom |
| | implementations. |
| Local storage ORM | The local storage ORM may provide the APIs |
| | needed for clients to access their data locally. This |
| | module may be a thin layer on top of the generated |
| | modules. |
| Sync module 412 | The sync module 412 may use the sync policies to |
| | determine how to remote sync the data from local |
| | storage. This module may also help manage the |
| | “dirty sets” of data that need to sync and apply the |
| | “remote data” to sync local storage. This module |
| | may further Interact with privacy and transport |
| | modules. |
| Privacy module 408 | The privacy module 408 may deal with the privacy |
| | policies associated with the data. |
| Transport module 410 | The transport module 410 may help with data |
| | transport across devices. This module may use |
| | both cloud frameworks as well as BT and peer to |
| | peer data transfer policies. |
| Metrics module | The metrics module may help log the useful |
| | metadata related to storage and sync of data |
| | types. This module may also have a server |
| | component to aggregate the server component |
| | into a helpful and usable dashboard for clients to |
| | use. |
| Tools | The tools may include server and local debug tools |
| | to help debug these complex flows. For instance, |
| | the tools may define what local E2EE keys are |
| | available, when keys were last rotated, what data |
| | type was uploaded on the server at what |
| | timestamp from which device, what data type got |
| | fetched/pushed from the server to which device at |
| | what timestamp, etc. |

Schemas may enable consistency for cross platform data access. As a result, schema definitions of each data type may be available on the apparatuses 100, 120a-120n. The storage ORM schemas may be used to define the data models, data access queries, etc., that a use case may need. The configuration schemas may capture the storage and sync policies for those data types such as:

| Sync Policy | Description |
|---|---|
| Security configurations | Security configurations may capture the security |
| | configs, such as read and write permissions, TTL. |
| Privacy configurations | Privacy configurations may determine privacy of |
| | the data, e.g., is the data going to be end-to-end |
| | encrypted at rest or not. |
| Data sync destinations | Data sync destinations may define the devices |
| | and apps to which the data should get synced. |
| Data sync sources | Data sync sources may define the devices and |
| | apps from where any remote data should be |
| | fetched. |
| Scheduled sync | Scheduled sync configuration may define |
| configuration | constraints, transport mode, cadence |
| | configurations, etc. |
| On-demand sync | On-demand sync configuration may define |
| configuration | constraints, transport mode, etc. |
| Pub-sub | Pub-sub may capture the pub-sub model of the |
| | data such as when/how to publish data to the |
| | Drive app & when/how to wake up the app |
| | readers on remote data updates. |

According to examples, the privacy module 408 may enable the privacy of data types that are getting synced via the server 130 to the remote apparatuses 120a-120n. The privacy module 408 may support the following modes:

| Modes | Description |
|---|---|
| No E2EE (End to End | No E2EE may not be recommended for any data |
| Encryption) | type that gets synced via the server 130. So for data |
| | types that do allow server based sync, evaluation |
| | and an understanding as to why this mode was |
| | chosen may need to be made and exception |
| | approvals may be needed. |
| | As an example, media since the product needs to |
| | support montage and memories use cases that need |
| | server processing. |
| E2EE with device - | This enables E2EE commitment for data access if |
| device key management | there are no use cases to fetch older historical data |
| | generated on older devices on a new device. |
| | This type of device key management may be |
| | relevant for use cases that typically overwrite and |
| | don't need to preserve historical data. For instance, |
| | last known device location for FindMy use case. |
| E2EE with hardware | This may enable E2EE commitment for data access |
| secure module based | if there are use cases to fetch older historical data |
| key management | generated on older devices on a new device. |
| | This is relevant for use cases that typically need to |
| | preserve all the historical data and make it available |
| | for users to access later on new devices. For |
| | instance, history of all workouts, system backups, |
| | etc. |

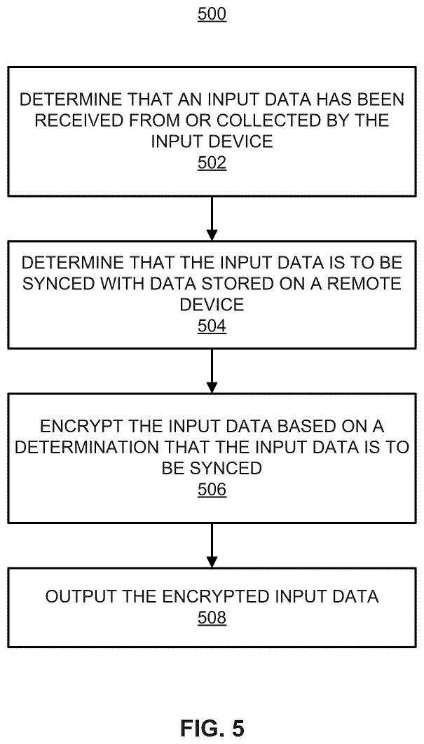

Various manners in which the processor 104 of the apparatus 100 may operate are discussed in greater detail with respect to the method 500 depicted in FIG. 5. FIG. 5 illustrates a flow diagram of a method 500 of syncing input data 112 with data on a remote apparatus 120a, according to an example of the present disclosure. It should be understood that the method 500 depicted in FIG. 5 may include additional operations and that some of the operations described therein may be removed and/or modified without departing from the scope of the method 500. The description of the method 500 is made with reference to the features depicted in FIGS. 1-4 for purposes of illustration.

At block 502, the processor 104 may determine that an input data 112 has been received from or collected by the input device 102. The input data 112 may be an instruction that a user has inputted to the apparatus 100 through the input device 102, data pertaining to a tracked feature of the apparatus 100 and/or a user of the apparatus 100.

At block 504, the processor 104 may determine that the input data 112 is to be synced with data stored on a remote apparatus 120a. As discussed herein, the processor 104 may determine that the input data 112 is to be synced based on the type of the input data 112 matching a certain type of data, based on the input data 112 being different from data at a previous synchronization event, and/or the like. For instance, the processor 104 may determine whether the input data 112 includes a type of data that is to be synced with the data stored on the remote apparatus to determine whether the input data 112 on the apparatus 100 is to be synced with data stored on the remote apparatus 120a. In addition, the processor 104 may determine that the input data is to be synced with the data stored on the remote apparatus based on a determination that the input data comprises a type of data that is to be synced with the data on the remote apparatus.

In addition, or alternatively, the processor 104 may determine whether the input data 112 includes data that has been changed from a prior synchronization event to determine whether the input data 112 on the apparatus 100 is to be synced with data stored on the remote apparatus 120a. The processor 104 may also determine that the input data 112 is to be synced with data stored on the remote apparatus 120a based on a determination that the input data 112 includes data that has been changed from the prior synchronization event.

At block 506, the processor 104 may encrypt the input data 112 based on a determination that the input data 112 is to be synced. The processor 104 may encrypt the input data 112 in any suitable manner, such as by using an end-to-end scheme as discussed herein. In addition, the processor 104 may encrypt the input data 112 using an encryption key that the server 130 may not possess and thus, may not be able to decrypt the inputted input data 112. The processor 104 may encrypt the input data 112 in this manner in instances in which the processor 104 is to output the encrypted input data 112 to the server 130.

At block 508, the processor 104 may output the encrypted input data 112. The processor 104 may output the encrypted input data 112 directly to the remote apparatus 120a and/or to the server 130 via a network 140.

Some or all of the operations set forth in the method 500 may be included as a utility, program, or subprogram, in any desired computer accessible medium. In addition, the method 500 may be embodied by a computer program, which may exist in a variety of forms both active and inactive. For example, they may exist as machine-readable instructions, including source code, object code, executable code or other formats. Any of the above may be embodied on a non-transitory computer readable storage medium.

Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

In the foregoing description, various inventive examples are described, including devices, systems, methods, and the like. For the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples.

The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example” is not necessarily to be construed as preferred or advantageous over other embodiments or designs.

Although the methods and systems as described herein may be directed mainly to digital content, such as videos or interactive media, it should be appreciated that the methods and systems as described herein may be used for other types of content or scenarios as well. Other applications or uses of the methods and systems as described herein may also include social networking, marketing, content-based recommendation engines, and/or other types of knowledge or data-driven systems.

1. An apparatus, comprising:
an input device;
a processor; and
a memory on which is stored machine-readable instructions that, when executed by the processor, cause the processor to:
determine that an input data has been received from or collected by the input device;
determine that the input data is to be synced with data stored on a remote apparatus; and
based on a determination that the input data is to be synced with data stored on the remote apparatus:
encrypt the input data; and
output the encrypted input data.

2. The apparatus of claim 1, wherein the input device comprises a sensor, a counter, a keyboard, a touchscreen display, a global positioning system device, a microphone, a camera, and/or a touchpad.

3. The apparatus of claim 1, wherein the instructions cause the processor to:
determine whether the input data comprises a type of data that is to be synced with the data stored on the remote apparatus; and
determine that the input data is to be synced with the data stored on the remote apparatus based on a determination that the input data comprises a type of data that is to be synced with the data stored on the remote apparatus.

4. The apparatus of claim 1, wherein the instructions cause the processor to:
determine whether the input data comprises data that has been changed from a prior synchronization event; and
determine that the input data is to be synced with data stored on the remote apparatus based on a determination that the input data comprises data that has been changed from the prior synchronization event.

5. The apparatus of claim 1, wherein the instructions cause the processor to:
determine that the apparatus is wirelessly connected to the remote apparatus; and
output the encrypted input data to the remote apparatus based on a determination that the apparatus is wirelessly connected to the remote apparatus.

6. The apparatus of claim 1, wherein the instructions cause the processor to:
encrypt the input data in a manner to prevent a server from being able to decrypt the input data; and
output the encrypted input data to the server via a network, wherein the remote apparatus is to obtain the encrypted input data from the server.

7. The apparatus of claim 1, wherein the apparatus comprises smartglasses, a smartwatch, a smartphone, a virtual reality headset, an augmented reality headset, a tablet computer.

8. The apparatus of claim 1, wherein the instructions cause the processor to:
receive remote data from the remote apparatus;
determine whether the remote data is to be synced with data stored in the apparatus; and
sync the remote data with the data stored on the apparatus based on a determination that the remote data is to be synced.

9. The apparatus of claim 8, wherein the instructions cause the processor to:
determine whether the remote data comprises a type of data that is to be synced with the data stored on the apparatus; and
determine that the remote data is to be synced with the data on the remote apparatus based on a determination that the remote data comprises a type of data that is to be synced with the data stored on the apparatus.

10. The apparatus of claim 8, wherein the instructions cause the processor to:
determine whether the remote data comprises data that has been changed from a prior synchronization event; and
determine that the remote data is to be synced with the data stored in the apparatus based on a determination that the remote data comprises data that has been changed from the prior synchronization event.

11. A method of syncing input data on an apparatus with data stored on a remote apparatus, the method comprising:
receiving or collecting, by a processor, an input data;
determining, by the processor, whether the input data is to be synced with data stored on the remote apparatus; and
based on a determination that the input data is to be synced with data stored on the remote apparatus:
encrypting, by the processor, the input data; and
outputting, by the processor, the encrypted input data.

12. The method of claim 11, further comprising:
determining whether input data comprises a type of data that is to be synced with the data stored on the remote apparatus to determine whether the input data on the apparatus is to be synced with data stored on the remote apparatus; and
determining that the input data is to be synced with the data stored on the remote apparatus based on a determination that the input data comprises a type of data that is to be synced with the data stored on the remote apparatus.

13. The method of claim 11, further comprising:
determining whether the input data comprises data that has been changed from a prior synchronization event to determine whether the input data on the apparatus is to be synced with data stored on the remote apparatus; and
determining that the input data is to be synced with data stored on the remote apparatus based on a determination that the input data comprises data that has been changed from the prior synchronization event.

14. The method of claim 11, further comprising:
determining whether the apparatus is wirelessly connected to the remote apparatus; and
outputting the encrypted input data to the remote apparatus based on a determination that the apparatus is wirelessly connected to the remote apparatus.

15. The method of claim 11, further comprising:
encrypting the input data in a manner to prevent a server from being able to decrypt the input data; and
outputting the encrypted input data to the server via a network, wherein the remote apparatus is to obtain the encrypted input data from the server.

16. The method of claim 11, further comprising:
receiving remote data from the remote apparatus;
determining whether the remote data is to be synced with data stored in the apparatus; and
syncing the remote data with the data stored on the apparatus based on a determination that the remote data is to be synced.

17. A non-transitory computer-readable storage medium having executable instructions stored thereon, which when executed instructs a processor to:
receive or collect, by an input device of an apparatus, an input data;
determine whether the input data is to be synced with data stored on a remote apparatus; and
based on a determination that the input data is to be synced with data stored on the remote apparatus:
encrypt the input data; and
output the encrypted input data to a server and/or the remote apparatus.

18. The non-transitory computer-readable storage medium of claim 17, wherein the instructions further instruct the processor to:
determine whether input data comprises a type of data that is to be synced with the data stored on the remote apparatus to determine whether the input data on the apparatus is to be synced with data stored on the remote apparatus; and
determine that the input data is to be synced with the data stored on the remote apparatus based on a determination that the input data comprises a type of data that is to be synced with the data on the remote apparatus.

19. The non-transitory computer-readable storage medium of claim 17, wherein the instructions further instruct the processor to:
determine whether the input data comprises data that has been changed from a prior synchronization event to determine whether the input data on the apparatus is to be synced with data stored on a remote apparatus; and
determine that the input data is to be synced with data stored on the remote apparatus based on a determination that the input data comprises data that has been changed from the prior synchronization event.

20. The non-transitory computer-readable storage medium of claim 17, wherein the instructions further instruct the processor to:
encrypt the input data in a manner to prevent a server from being able to decrypt the input data; and
output the encrypted input data to the server via a network, wherein the remote apparatus is to obtain the encrypted input data from the server.
